(19) United States
(12) Patent Application Publication
(10) Pub. No.: US 2012/0106186 A1
(43) Pub. Date: May 3, 2012

(54) ILLUMINATION APPARATUS AND VEHICULAR HEADLAMP

(75) Inventors: Katsuhiko KISHIMOTO, Osaka-shi (JP); Kohsei Takahashi, Osaka-shi (JP)

(73) Assignee: Sharp Kabushiki Kaisha, Osaka-shi (JP)

(21) Appl. No.: 13/282,155

(22) Filed: Oct. 26, 2011

(30) Foreign Application Priority Data
Oct. 29, 2010 (JP) 2010-244572

(51) Int. Cl. F21V 9/00; H01J 1/70

(52) U.S. Cl. 362/510; 313/503

(57) ABSTRACT

A headlamp includes (i) a semiconductor laser for emitting laser beams, (ii) a light emitting section that includes a first fluorescent material having a peak of emission spectrum which peak falls within a range from 450 nm to 500 nm, and that emits white fluorescence while being irradiated with exciting light emitted from the semiconductor laser, and (iii) a transmission filter for shielding the laser beams and transmitting the fluorescence emitted from the light emitting section.

This Nonprovisional application claims priority under 35 U.S.C. §119(a) on Patent Application No. 2010-244572 filed in Japan on Oct. 29, 2010, the entire contents of which are hereby incorporated by reference.

### TECHNICAL FIELD

The present invention relates to an illumination apparatus, particularly to a vehicular headlamp, which includes an excitation light source and a light emitting section that emits fluorescence while being irradiated with exciting light emitted from the excitation light source.

### BACKGROUND ART

Recently, there has been eagerly studied an illumination apparatus that employs, as illumination light, fluorescence generated by irradiation of a light emitting section, including a fluorescent material, with exciting light emitted from a semiconductor light emitting device such as a light emitting diode (LED) or a semiconductor laser diode (LD) that serves as an excitation light source.

Patent Literature 1 discloses an example of such an illumination apparatus. The illumination apparatus uses a semiconductor laser as an excitation light source so as to obtain a high-luminance light source. The semiconductor laser emits coherent laser beams having a great directivity.

Accordingly, the illumination apparatus can converge and use the laser beams as exciting light without wasting the laser beams at all. Further, the illumination apparatus is designed such that the laser beams do not leak outside the illumination apparatus by, for example, (i) employing, as illumination light, fluorescence emitted from the light emitting section after a light emitting section including a fluorescent material is irradiated with laser beams and/or (ii) providing, on a side where the illumination apparatus emits light, a filter for shielding the laser beams.

Patent Literatures 2 through 4 disclose examples of oxynitride fluorescent materials.

### CITATION LIST

### Patent Literature

Patent Literature 1

Japanese Patent Application Publication, Tokukai No. 2005-150041 A (Publication Date: Jun. 9, 2005)

Patent Literature 2

Japanese Patent Application Publication, Tokukai No. 2007-332217 A (Publication Date: Dec. 27, 2007)

Patent Literature 3

Japanese Patent Application Publication, Tokukai No. 2007-326914 A (Publication Date: Dec. 20, 2007)

Patent Literature 4

Japanese Patent Application Publication, Tokukai No. 2007-204730 A (Publication Date: Aug. 16, 2007)

### SUMMARY OF INVENTION

### Technical Problem

In a field, such as an automotive headlamp, in which white light having a high color temperature is required, an illumination apparatus capable of emitting white light having such a high color temperature has been required.

Coherent components included in laser beams are likely to damage human eyes. In view of the circumstances, a conventional illumination apparatus disclosed in, for example, Patent Literature 1 has been designed such that exciting light emitted from an excitation light source does not leak outside the illumination apparatus. This allows safety of particularly human eyes to be maximally secured. Specifically, in the conventional illumination apparatus, a filter for shielding laser beams emitted from a semiconductor laser is provided in an opening of a reflector. This makes it difficult to increase a color temperature of illumination light by use of the laser beams.

Meanwhile, usage of a blue fluorescent material makes it possible to logically increase the color temperature of illumination light. However, the blue fluorescent material, which has a great light emitting efficiency and is suitable for an illumination apparatus including a semiconductor laser, has been hard to find. As such, it has been difficult to increase the color temperature of illumination light by use of the blue fluorescent material. Patent Literature 1 is silent about a concrete fluorescent material included in a light emitting section. Therefore, of course, the illumination apparatus of Patent Literature 1 is not configured in view of a problem of difficulty in increasing the color temperature of white light emitted from the illumination apparatus.

The present invention was made in view of the problem, and an object of the present invention is to provide an illumination apparatus and a vehicular headlamp each capable of increasing a color temperature of illumination light to be emitted outside corresponding one of the illumination apparatus and the vehicular headlamp.

### Solution To Problem

In order to attain the object, an illumination apparatus of the present invention, including: an excitation light source for emitting exciting light; a light emitting section that includes a first fluorescent material having a peak of emission spectrum which peak falls within a range from 450 nm to 500 nm, and that emits white fluorescence while being irradiated with the exciting light emitted from the excitation light source; and a transmission filter for shielding the exciting light and transmitting the fluorescence emitted from the light emitting section.

According to the configuration, the light emitting section emits the fluorescence while being irradiated with the exciting light emitted from the excitation light source, and then the fluorescence is emitted via the transmission filter. In this case, the exciting light does not leak outside the illumination apparatus because the exciting light is shielded by the transmission filter. This makes it possible to prevent human eyes from being damaged by the exciting light emitted outside without being converted into fluorescence (or being scattered).

Further, the light emitting section of the illumination apparatus of the present invention includes the first fluorescent material having the peak of emission spectrum which peak falls within a range from 450 nm to 500 nm, that is, a first fluorescent material containing plenty of blue components. This allows the illumination apparatus of the present invention to increase a color temperature of the white light emitted from the light emitting section, as shown in, for example, FIG. 2. It is therefore possible to emit, as illumination light, white light having a desired color temperature even in a case where the transmission filter for shielding exciting light is provided in the illumination apparatus.

This allows the illumination apparatus of the present invention to emit white light that secures safety and that has a high color temperature.

Note that the transmission filter does not need to shield all exciting light, and to transmit all fluorescence emitted from the light emitting section.

### Advantageous Effects of Invention

As described above, an illumination apparatus of the present invention, including: an excitation light source for emitting exciting light; a light emitting section that includes a first fluorescent material having a peak of emission spectrum which peak falls within a range from 450 nm to 500 nm, and that emits white fluorescence while being irradiated with the exciting light emitted from the excitation light source; and a transmission filter for shielding the exciting light and transmitting the fluorescence emitted from the light emitting section.

This allows the illumination apparatus of the present invention to emit white light that secures safety and that has a high color temperature.

### BRIEF DESCRIPTION OF DRAWINGS

FIG. 1

FIG. 1 is a view schematically showing a configuration of a headlamp in accordance with an embodiment of the present invention.

FIG. 2

FIG. 2 is a graph showing a chromaticity range of white required for a vehicular headlamp, and a view showing a chromaticity of illumination light emitted by a light emitting section in which an oxynitride fluorescent material containing a JEM phase is used as a first fluorescent material.

FIG. 3

FIG. 3 is a graph showing a chromaticity range of white required for a vehicular headlamp, and a view showing a chromaticity of illumination light emitted by a light emitting section in which a Caα-SiAlON:Ce fluorescent material is used as a fluorescent material.

FIG. 4(a)

FIG. 4(a) is a view schematically showing a circuit of a semiconductor laser.

FIG. 4(b)

FIG. 4(b) is a perspective view showing a basic configuration of a semiconductor laser.

FIG. 5

FIG. 5 is a cross-sectional view schematically showing a configuration of a headlamp in accordance with another embodiment of the present invention.

FIG. 6

FIG. 6 is a view showing a positional relationship of an end part of an optical fiber with a light emitting section that are included in a headlamp in accordance with another embodiment of the present invention.

FIG. 7

FIG. 7 is a view schematically showing external appearances of (i) a light emitting unit included in a laser down light in accordance with an embodiment of the present invention and (ii) a conventional LED down light.

FIG. 8

FIG. 8 is a cross-sectional view of a ceiling on which the laser down light is provided.

FIG. 9

FIG. 9 is a cross-sectional view of the laser down light.

FIG. 10

FIG. 10 is a cross-sectional view showing a modified example of a method for providing the laser down light.

FIG. 11

FIG. 11 is a cross-sectional view of a ceiling on which the LED down light is provided.

FIG. 12

FIG. 12 shows a comparison of specifications of the laser down light and the LED down light.

### DESCRIPTION OF EMBODIMENTS

### Embodiment 1

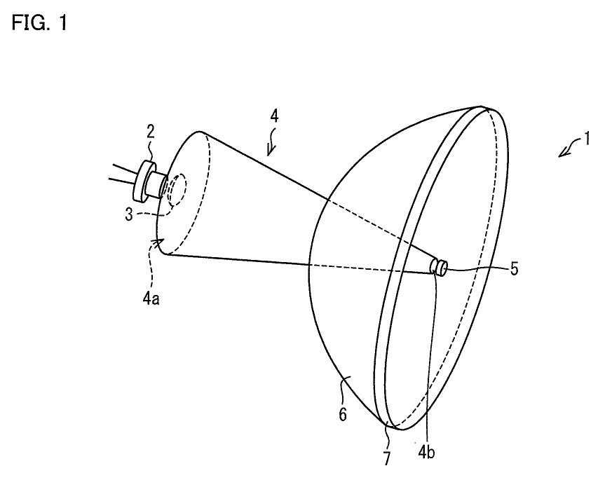

The following describes an embodiment of the present invention with reference to FIGS. 1 through 6.

### Technical Idea of the Present Invention

In a case where (i) a semiconductor laser is used as an excitation light source and (ii) exciting light is emitted outside from the semiconductor laser, the exciting light is likely to damage human eyes because the exciting light mostly contains coherent components. Therefore, an illumination apparatus, including a semiconductor laser as an excitation light source, should be designed so as to shield exciting light. For example, in the illumination apparatus, a transmission filter is provided so as to shield the exciting light. In this case, however, the exciting light and exciting light containing blue components are both shielded by the transmission filter. As such, it has been difficult to increase a color temperature of illumination light (white light) by use of the exciting light. Inventors of the present invention found, in view of the circumstances, that it is possible to increase a color temperature of white light emitted from the light emitting section, by using a fluorescent material containing plenty of blue components as a fluorescent material included in a light emitting section, thereby increasing a color temperature of illumination light emitted from the illumination apparatus.

An illumination apparatus in accordance with an embodiment of the present invention was made on the basis of such a technical idea. According to the illumination apparatus, even in a case where the exciting light is shielded, the color temperature of white light emitted from the light emitting section can be increased by using the fluorescent material containing blue components as the fluorescent material included in the light emitting section. This embodiment exemplifies, as the illumination apparatus in accordance with an embodiment of the preset invention, a headlamp (illumination apparatus or vehicular headlamp) 1 that meets standards of a light distribution property of an automotive headlamp (high beam). Note, however, that the illumination apparatus of the present invention is not limited to this embodiment. The illumination apparatus of the present invention is applicable to (i) a headlamp that meets standards of a light distribution property of an automotive low-beam headlamp (low beam), (ii) a headlamp of vehicles other than automobile or a movable object (such as human, ship, aircraft, submarine or rocket) or (iii) other illumination apparatuses such as a searchlight.

### Configuration of Headlamp 1

The following describes a configuration of a headlamp 1 in accordance with the present embodiment with reference to FIG. 1. FIG. 1 is a view schematically showing the configuration of the headlamp 1 in accordance with the present embodiment. As shown in FIG. 1, the headlamp 1 includes a semiconductor laser 2 (excitation light source), an aspheric lens 3, a light guiding section 4, a light emitting section 5, a reflector 6 and a transmission filter 7.

### Semiconductor Laser 2

The semiconductor laser 2 functions as an excitation light source for emitting exciting light. The headlamp 1 can include a single semiconductor laser 2, alternatively can include a plurality of semiconductor lasers 2. Further, a semiconductor laser 2 in which each chip has a single light emitting point can be used, alternatively a semiconductor laser 2 in which each chip has a plurality of light emitting points can be used. In the present embodiment, the semiconductor laser 2 in which each chip has a single light emitting point is used.

For example, the semiconductor laser 2 in which each chip has a single light emitting point (one stripe) has an optical output of 1.0-watt, emits laser beams having an oscillation wavelength of 405 nm (bluish purple), and operates at 5 V and 0.7 A. The semiconductor laser 2 is sealed in a package (stem) having a diameter of 5.6 mm. In the present embodiment, 10 (ten) semiconductor lasers 2 are used. That is, the headlamp 1 has a total optical output of 10 W. Note, however, that only one of the 10 semiconductor lasers 2 is shown in FIG. 1 for the sake of convenience.

The oscillation wavelength of the semiconductor laser 2 is not limited to 405 nm. The semiconductor laser 2 can preferably have a peak wavelength (peak wavelength of emission spectrum) which falls within a range from 350 nm to 460 nm, and can more preferably have a peak wavelength (peak wavelength of emission spectrum) which falls within a range from 350 nm to 420 nm.

In a case where the semiconductor laser 2 has an oscillation wavelength which falls within a range from 350 nm to 420 nm, it is possible to broaden the range of choice for a second fluorescent material used in combination with a first fluorescent material (having a peak wavelength of emission spectrum which peak falls within a range from 450 nm to 500 nm) so as to form the light emitting section 5 that emits white light. Specifically, it becomes possible to use, as the second fluorescent material, a fluorescent material having a peak wavelength of emission spectrum, which peak wavelength falls within a range from 580 nm to 650 nm. Further, in a case where the peak wavelength of emission spectrum of the semiconductor laser 2 falls within a range from 350 nm to 420 nm, it is possible to conform such a range to a range of an excitation wavelength of oxynitride fluorescent material containing a JEM phase that is used as the first fluorescent material of the light emitting section 5.

In a case where (i) the oxynitride fluorescent material containing JEM phase is used as the first fluorescent material and (ii) the peak wavelength of emission spectrum of the semiconductor laser 2 has a range from ultraviolet light to bluish purple visible light (not less than 350 nm but not more than 380 nm or less than 400 nm), it is possible to excite, at a high efficiency (approximately 60%), the oxynitride fluorescent material containing JEM phase. Note that the oxynitride fluorescent material containing JEM phase is most efficiently excited in a case where exciting light has a peak wavelength of emission spectrum of 360 nm. Further, the oxynitride fluorescent material containing JEM phase can also be excited at a high efficiency (approximately 50%) even in a case where the peak wavelength of emission spectrum of the semiconductor laser 2 has a bluish purple range from 400 nm to 420 nm.

That is, the oxynitride fluorescent material containing JEM phase can be efficiently excited in a case where the semiconductor laser 2 emits laser beams having a peak of oscillation wavelength which peak falls within a range from 350 nm to 420 nm. It is therefore possible that the light emitting section 5 has a great emission efficiency.

In a case where an oxynitride fluorescent material or a nitride fluorescent material is used as the fluorescent material of the light emitting section 5, it is preferable that (i) the semiconductor laser 2 has an optical output of not less than 1 W but not more than 20 W and (ii) the light emitting section 5 is irradiated with the laser beams having a light concentration which falls with in a range from 0.1 W/mm² to 50 W/mm². In this case, it is possible to (a) achieve the light flux and the luminescence that are required for a vehicular headlamp and (b) prevent the light emitting section 5 from being extremely deteriorated by laser beams having a high optical output. That is, it is possible to provide a light source having high light flux and high luminescence while securing a longer operating life.

Note that the laser beams with which the light emitting section 5 is irradiated can have a light concentration of more than 50 W/mm² in a case where a semiconductor nanoparticle fluorescent material (later described) is used as the fluorescent material of the light emitting section 5.

### Aspheric Lens 3

The aspheric lens 3 is a lens through which laser beams emitted from the semiconductor laser 2 enter an incident surface 4a that is an end part of the light guiding section 4. For example, FLKN1 405 manufactured by ALPS ELECTRIC CO., LTD. can be used as the aspheric lens 3. However, a shape and a material of the aspheric lens 3 are not particularly limited, provided that the aspheric lens 3 has the above-described function. But yet, the aspheric lens 3 is preferably made from a heat-resistant material which greatly transmits a light beam having a wavelength of approximately 405 nm which is a wavelength of the exciting light.

The aspheric lens 3 converges laser beams emitted from the semiconductor laser 2 so as to guide the laser beams toward a relatively small incident surface (for example, a surface having a diameter of not more than approximately 1 mm). Therefore, in a case where the incident surface 4a of the light guiding section 4 is large enough for laser beams not to need to be converged, the aspheric lens 3 does not need to be provided.

### Light Guiding Section 4

The light guiding section 4 is a light guiding member, having a truncated cone shape, for converging and guiding laser beams emitted from the semiconductor laser 2 toward the light emitting section 5 (a laser beam irradiated surface of the light emitting section 5). The light guiding section 4 is optically coupled to the semiconductor laser 2 via the aspheric lens 3 or directly. The light guiding section 4 includes (i) the incident surface 4a (an incident end part) for receiving the laser beams emitted from the semiconductor laser 2 and (ii) a light emitting surface 4b (light emitting end part) from which the laser beams received by the incident surface 4a is emitted toward the light emitting section 5.

The light emitting surface 4b has an area smaller than that of the incident surface 4a. This causes the laser beams that enter the incident surface 4a to be converged by traveling toward the light emitting surface 4b while being reflected from an inner side surface of the light guiding section 4 and then to be emitted from the light emitting surface 4b.

The light guiding section 4 is made from BK7 (borosilicate crown glass), quartz glass, acrylic resin or other transparent materials. The incident surface 4a and the light emitting surface 4b can be planar or curved.

Further, the light guiding section 4 are not limited to a specific one, and can therefore have a truncated pyramid shape or the light guiding section 4 can be optical fiber, provided that it guides, toward the light emitting section 5, the laser beams emitted from the semiconductor laser 2. Alternatively, the light emitting section 5 can be irradiated, via the aspheric lens 3 or directly, with the laser beams emitted from the semiconductor laser 2 instead of providing the light guiding section 4 in the headlamp 1. Specifically, in a case where the semiconductor laser 2 is not far from the light emitting section 5, the light guiding section 4 does not need to be provided in the headlamp 1.

### Composition of Light Emitting Section 5

The light emitting section 5 emits white fluorescence while it is being irradiated with the laser beams emitted from the light emitting surface 4b of the light guiding section 4. In the light emitting section 5, plural types of fluorescent materials, which emit light while being irradiated with laser beams, are dispersed in fluorescent material retention materials (sealing materials). Specifically, the light emitting section 5 includes a first fluorescent material, and a second fluorescent material having a peak of emission spectrum different from that of the first fluorescent material.

The first fluorescent material has, for example, a peak of emission spectrum in a range of wavelength from 450 nm to 500 nm. The second fluorescent material has, for example, a peak of emission spectrum which falls within a range from 580 nm to 650 nm. The upper limit of the range of the second fluorescent material can be greater than 650 nm, provided that the second fluorescent material emits light visible to human eyes. However, the upper limit is preferably 650 nm in view of practicality. The reason is as follows. In a case where the second fluorescent material has a peak of emission spectrum of greater than 650 nm, it becomes impossible to obtain sufficiently bright illumination light because spectral luminous efficacy is too low.

Each of the first and second fluorescent materials is an oxynitride or nitride fluorescent material. A typical example of the oxynitride fluorescent material is a commonly called SiAlON (silicone aluminum oxynitride) fluorescent material. The SiAlON fluorescent material is obtained by (i) replacing some silicon atoms of silicon nitride by aluminum atoms and (ii) replacing some nitrogen atoms of the silicon nitride by oxygen atoms. The SiAlON fluorescent material can be prepared by dissolving alumina (Al₂O₃), silica (SiO₂), a rare earth element and the like in silicon nitride (Si₃N₄) so as to form a solid solution thereof.

The first fluorescent material is, for example, an oxynitride fluorescent material containing JEM phase (JEM phase fluorescent material). The JEM phase fluorescent material has been confirmed to be produced in a process of adjusting a SiAlON fluorescent material stabilized by a rare earth element. The JEM phase is a ceramics found as a grain boundary phase of a silicon nitride material. The JEM phase is generally expressed by a composition formula M¹Al (Si_{6-z}Al_{z}) N_{10-z}O_{z} (note than M¹ is at least one element selected from the group consisting of La, Ce, Pr, Nd, Sm, Eu, Gd, Tb, Dy, Ho, Er, Tm, Yb and Lu). Namely, the JEM phase is a crystal phase (oxynitride crystal), having a unique atom arrangement, which has a composition in which z is a parameter. The JEM phase is excellent in heat resistance because the JEM phase is a crystal which has strong covalent binding.

It is also preferable that the first fluorescent material be a JEM phase fluorescent material including Ce³⁺ (JEM phase: Ce fluorescent material). Since the JEM phase fluorescent material contains a Ce component, it is possible to cover, for example, a wavelength domain in which relative luminosity is high in case of scotopic vision because (i) it becomes easy to absorb exciting light having wavelengths which fall within a range of the order of 350 nm to 400 nm thereby obtaining emissions of light from blue to bluish green and (ii) half bandwidth of the emission becomes broad. The JEM phase:Ce fluorescent material has a peak wavelength of 480 nm and an emission efficiency of 60% in a case where an excitation wavelength is 360 nm. The JEM phase:Ce fluorescent material has a peak wavelength of 490 nm and an emission efficiency of 50% in a case where the excitation wavelength is 405 nm. A composition, a manufacturing method and the like of the JEM phase fluorescent material are concretely disclosed in, for example, Patent Literatures 2 through 4.

In other words, the light emitting section 5 includes the first fluorescent material having a peak of emission spectrum which peak falls within a range from 450 nm to 500 nm, and the JEM fluorescent material is used as the first fluorescent material. Note that the first fluorescent material is not limited to the JEM phase fluorescent material. For example, it is therefore possible to use, as the first fluorescent material, an oxynitride or nitride fluorescent material having a peak of emission spectrum which peak falls within a range from 450 nm to 500 nm.

Meanwhile, the second fluorescent material is, for example, a CaAlSiN₃:Eu²⁺ fluorescent material (CASN:Eu fluorescent material) or a SrCaAlSiN₃:Eu²⁺ fluorescent material (SCASN:Eu fluorescent material) that is a nitride fluorescent material or a Caα-SiAlON:Eu²⁺ (Caα-SiAlON:Eu fluorescent material) that is an oxynitride fluorescent material.

In a case where the excitation wavelength ranges from 350 nm to 450 nm, the CASN:Eu fluorescent material emits red fluorescence having a peak wavelength of 650 nm, and has an emission efficiency of 73%. Meanwhile, in the case where the excitation wavelength ranges from 350 nm to 450 nm, the SCASN:Eu fluorescent material emits red fluorescence having a peak wavelength of 630 nm, and has an emission efficiency of 70%.

In other words, the light emitting section 5 includes the second fluorescent material having a peak of emission spectrum which peak falls within a range from 630 nm to 650 nm, and the CASN:Eu fluorescent material or the SCASN:Eu fluorescent material is used as the second fluorescent material. In a case where such a red fluorescent material is used in combination with the first fluorescent material, it is possible to emit white light having a remarkably high color temperature. In a case where a target to be irradiated with the white light is red, the red fluorescent material makes it possible to enhance a visibility to the target. Traffic signs have a red, yellow or blue background color. Therefore, the red fluorescent material used in the light emitting section 5 of the headlamp 1 is effective in viewing a traffic sign whose background color is red.

In a case where the excitation wavelength is 405 nm, the Caα-SiAlON:Eu fluorescent material emits orange fluorescence having a peak wavelength of 580 nm, and has an emission efficiency of 65%. An α-type SiAlON fluorescent material has a highly stable crystal structure. Therefore, the α-type SiAlON fluorescent material is suitable for an illumination apparatus that employs laser beams as exciting light.

As described above, each of the fluorescent materials has a high emission intensity. Each of the fluorescent materials also has a high heat resistance. Therefore, the light emitting section 5 is unlikely to deteriorate even in a case where the light emitting section 5 is irradiated with exciting light having high optical output and high light concentration. It is thus possible to produce a headlamp that emits white light having high luminescence and high light flux by using these fluorescent materials as the first and second fluorescent materials.

The second fluorescent material can be a semiconductor nanoparticle fluorescent material made from nanometer-scale particles of a III-V compound semiconductor. A feature of the semiconductor nanoparticle fluorescent material resides in that, even in a case where a compound semiconductor (for example, indium phosphide: InP) is used, an emission color can be changed by a quantum size effect which is obtained by changing a particle size of such a compound semiconductor into a nanometer particle size. For example, InP, having a particle size of the order of 3 nm to 4 nm, emits red light. Note that the particle size is evaluated by a transmission electron microscope (TEM).

The semiconductor nanoparticle fluorescent material is made from a semiconductor. Therefore, the semiconductor nanoparticle fluorescent material has a short luminescence life, and can quickly emit a power of exciting light as fluorescence. This allows the semiconductor nanoparticle fluorescent material to also have a strong resistance to the exciting light having high power. This is because the semiconductor nanoparticle fluorescent material has an emission life of as short as approximately 10 nanoseconds, which is 5 digits shorter than that of a normal fluorescent material in which rare earth is luminescence center.

As described above, the semiconductor nanoparticle fluorescent material has a short emission life. Therefore, the semiconductor nanoparticle fluorescent material can quickly and repetitively carry out absorption of laser beams and emission of fluorescence. This allows the semiconductor nanoparticle fluorescent material to retain a high conversion efficiency with respect to strong laser beams, and to reduce heat generated by the semiconductor nanoparticle fluorescent material. Hence, a deterioration (change in color and/or deformation) in the light emitting section 5 due to heat can be further suppressed. This allows the headlamp 1 to extend its operating life.

The sealing material is preferably a low-melting inorganic glass. However, the sealing material can be made from organic/inorganic hybrid glass or a resin such as silicone resin in a case where the sealing material is not irradiated with exciting light having a remarkably high optical output and high-concentration. Note that the light emitting section 5 can be prepared by pressing and hardening merely the fluorescent material. Meanwhile, it is preferable that the light emitting section 5 is prepared by dispersing the fluorescent material in the sealing material. This is because the deterioration in the light emitting section 5, caused by irradiation of the light emitting section 5 with laser beams, is likely to be accelerated in a case where the light emitting section 5 is prepared by pressing and hardening merely the fluorescent material.

### EXAMPLE

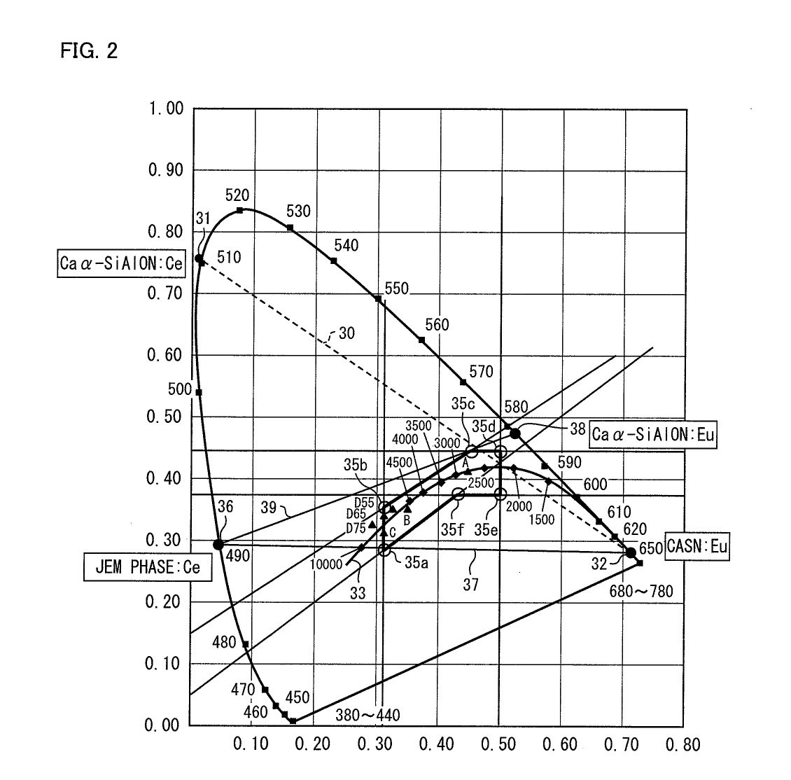

The following describes, with reference to FIG. 2, why the headlamp 1 including the light emitting section 5 can emit white light having a high chromaticity. FIG. 2 is a graph showing a chromaticity range of white required for a vehicular headlamp, and FIG. 2 shows a chromaticity of illumination light obtained in a case where a JEM phase:Ce fluorescent material is used as a first fluorescent material. As shown in FIG. 2, the chromaticity range of white required for the vehicular headlamp is required by law. The chromaticity range is in a polygon defined by six apexes 35a through 35f. A curved line 33 shows a color temperature (K: Kelvin). In FIG. 2, the second fluorescent material uses a CASN:Eu fluorescent material as a red fluorescent material, and uses a Caα-SiAlON:Eu fluorescent material as an orange fluorescent material.

The light emitting section 5, including (i) the JEM phase:Ce fluorescent material and (ii) the CASN:Eu fluorescent material or the Caα-SiAlON:Eu fluorescent material, is irradiated with laser beams having an oscillation wavelength of 405 nm which are emitted from the semiconductor laser 2, so that the light emitting section 5 emits illumination light. A ratio between the first and second fluorescent materials in the light emitting section 5 is adjusted so as to obtain white light (i) that has a color temperature of 3000 K to 7000 K and (ii) that is complied with a range of white required for a headlight, which range is required by the Road Trucking Vehicle Law,. The adjustment demonstrates that a ratio between (i) the JEM phase:Ce fluorescent material and (ii) the CASN:Eu fluorescent material or the Caα-SiAlON:Eu fluorescent material is preferably approximately (5 through 10):1. In the present embodiment, the ratio is 6:1. Even in a case where the SCASN:Eu fluorescent material is used as the second fluorescent material, a ratio between the JEM phase:Ce fluorescent material and the SCASN:Eu fluorescent material is preferably (5 through 10):1. Note that the color temperature can be adjusted to be a color temperature that most users like in the market.

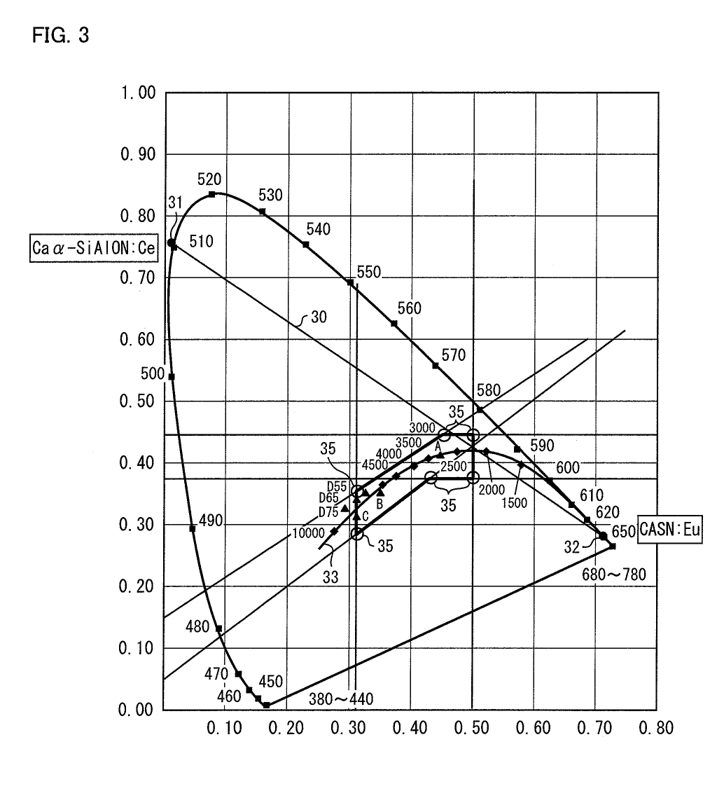

The following description discusses, with a comparative example, how much a color temperature of light can be increased in a case where the JEM phase:Ce fluorescent material is used, with reference to FIG. 3. The comparative example uses, as a fluorescent material, a Caα-SiAlON:Ce³⁺ fluorescent material (Caα-SiAlON:Ce fluorescent material). FIG. 3 is a graph (chromaticity diagram) showing a chromaticity range of white required for a vehicular headlamp. FIG. 3 shows a chromaticity of illumination light obtained in a case where the Caα-SiAlON:Ce fluorescent material and the CASN:Eu fluorescent material are used. Note that FIG. 2 is identical in chromaticity diagram itself to FIG. 3, and therefore, in FIG. 3, reference numerals identical to those of FIG. 2 are assigned to identical coordinates, straight lines, and the like. For example, a straight line (dashed line) 30 of FIG. 2 is identical to a straight line 30 of FIG. 3. Dots 35 of FIG. 3 are identical to the respective apexes 35a through 35f.

The Caα-SiAlON:Ce fluorescent material has a peak wavelength of over 500 nm. Accordingly, a color of light emitted from the Caα-SiAlON:Ce fluorescent material contains less blue components. This makes it difficult to emit white light having a high color temperature in a case where exciting light is shielded.

Specifically, the Caα-SiAlON:Ce fluorescent material has a peak wavelength of 510 nm in a case where an excitation wavelength is 405 nm. Therefore, for example, the CASN:Eu fluorescent material having a peak wavelength of 650 nm is used in combination with the Caα-SiAlON:Ce fluorescent material so that white light having a high color temperature is emitted. It is assumed here that a light emitting section including these fluorescent materials is irradiated with laser beams having an oscillation wavelength of 405 nm by a semiconductor laser, all of the laser beams are converted into fluorescence or scattered by the light emitting section, all of scattered laser beams are shielded, and merely fluorescence emitted from the light emitting section is employed as illumination light (all of the laser beams emitted from the semiconductor laser are shielded).

Under the assumption, a color (chromaticity) of the illumination light is only on the straight line 30 defined by (i) a dot 31 indicating the peak wavelength of the Caα-SiAlON:Ce fluorescent material and (ii) a dot 32 indicating the peak wavelength of the CASN:Eu fluorescent material (see FIG. 3). Even in a case where the ratio between the Caα-SiAlON:Ce fluorescent material and the CASN:Eu fluorescent material is adjusted so that white light corresponding to inside of a polygon shown in FIG. 3 is emitted, the light emitting section merely emits white light having a color temperature of the order of 2000 K to 3500 K (extremely low color temperature of the order of bulb light color). Note that the color temperature may range slightly broader than a theoretical value because emission spectrums of the Caα-SiAlON:Ce fluorescent material and the CASN:Eu fluorescent material have their respective half bandwidths.

That is, it is difficult for the combination of the Caα-SiAlON:Ce fluorescent material and the CASN:Eu fluorescent material to increase the color temperature of the illumination light.

Meanwhile, in the present embodiment, the JEM phase: Ce fluorescent material (having a peak wavelength of 490 nm) and the CASN:Eu fluorescent material (having a peak wavelength of 650 nm) are used as the first fluorescent material and the second fluorescent material, respectively. In this case, a color (chromaticity) of illumination light is on a straight line 37 defined by (i) a dot 36 indicating the peak wavelength of the JEM phase:Ce fluorescent material and (ii) a dot 32 indicating the peak wavelength of the CASN:Eu fluorescent material (see FIG. 2). As described above, in the case where, for example, the ratio between the JEM phase:Ce fluorescent material and the CASN:Eu fluorescent material is 6:1, the straight line 37 passes in the vicinity of the dot 35a. This satisfies the chromaticity range of white required for the vehicular headlamp. In a case where the light emitting section is irradiated with laser beams having an oscillation wavelength of 405 nm, white light having a remarkably high color temperature of approximately 7000 K is emitted from the light emitting section 5. That is, by using the JEM phase:Ce fluorescent material in combination with the red fluorescent material, it is possible to generate laser beams that enables white light having a remarkably high color temperature to be emitted.

By changing the ratio between the JEM phase:Ce fluorescent material and the CASN:Eu fluorescent material, it is possible to emit white light (i) that has a chromaticity in a range other than the chromaticity range of white required for the vehicular headlamp (a range of the polygon defined by the apexes 35a through 35f) and (ii) that has a color temperature higher than that of white light obtained in a case where the Caα-SiAlON:Ce fluorescent material is used as the first fluorescent material. For example, it is possible to generate white light having a remarkably high color temperature of approximately 10000 K. That is, in a field different from the vehicular headlamp such as a field where white light having a high color temperature is required, it is also possible to emit white light, by use of the light emitting section 5, which meets the requirement.

Meanwhile, in a case where the JEM phase:Ce fluorescent material (having a peak wavelength of emission spectrum of 490 nm) and the Caα-SiAlON:Eu fluorescent material (having a peak wavelength of emission spectrum of approximately 580 nm to 585 nm) are used as the first fluorescent material and the second fluorescent material, respectively, a color of illumination light is on a straight line 39 defined by (i) the dot 36 indicating the peak wavelength of the JEM phase:Ce fluorescent material and (ii) a dot 38 indicating the peak wavelength of the Caα-SiAlON:Eu fluorescent material. In a case of the above-described ratio, the straight line 39 passes in the vicinity of the dot 35c. This satisfies the chromaticity range of white required for the vehicular headlamp. In a case where the light emitting section is irradiated with laser beams having an oscillation wavelength of 405 nm, white light having a color temperature of the order of 3000 K to 4000 K is emitted from the light emitting section 5.

That is, even in the case where the Caα-SiAlON:Eu fluorescent material is used as the second fluorescent material, the light emitting section 5 can emit white light (i) that has a chromaticity in the chromaticity range of white required for the vehicular headlamp and (ii) that has a color temperature higher than that of white light obtained in a case where the Caα-SiAlON:Ce fluorescent material and the CASN:Eu fluorescent material are used as the second fluorescent material (straight line 30). Further, in a case where the JEM phase:Ce fluorescent material is used as the first fluorescent material, the light emitting section 5 can emit white light having a color temperature higher and broader than those of white light obtained in a case where the Caα-SiAlON:Ce fluorescent material is used as the first fluorescent material.

By changing the ratio between the JEM phase:Ce fluorescent material and the Caα-SiAlON:Eu fluorescent material, it is possible to emit white light (i) that has a chromaticity in a range other than the chromaticity range of white required for the vehicular headlamp and (ii) that has a color temperature higher than that of white light obtained in the case where the Caα-SiAlON:Ce fluorescent material is used as the first fluorescent material, as with the case where the CASN:Eu fluorescent material is used as the second fluorescent material. In the field different from the vehicular headlamp such as a field where white light having a high color temperature is required, it is also possible to emit white light, by the light emitting section 5, which meets the requirement. Note that the Caα-SiAlON:Eu fluorescent material having a peak wavelength of emission spectrum of 580 nm can be used so as to emit white light (i) that has a chromaticity in a range other than the chromaticity range of white and (ii) that has a high color temperature, in a case where the light emitting section 5 is used in an illumination apparatus that belongs to the field different from the vehicular light.

In a case where the SCASN:Eu fluorescent material (having a peak wavelength of emission spectrum of 630 nm) that is a red fluorescent material is used as the second fluorescent material, a color of illumination light is on a straight line (not shown) defined by the dot 36 and a dot of 630 nm in the chromaticity diagram of FIG. 2. In this case, the light emitting section 5 can emit white light having (i) a color temperature higher than that of white light emitted in the case where the Caα-SiAlON:Ce fluorescent material is used as the first fluorescent material and (ii) a color temperature slightly lower than that of white light emitted in the case where the CASN:Eu fluorescent material is used as the second fluorescent material.

As described above, in the case where the JEM phase: Ce fluorescent material is used as the first fluorescent material, the light emitting section 5 can emit white light having a color temperature higher and boarder (that is, a desired color temperature) than those of white light obtained in a case where the Caα-SiAlON:Ce fluorescent material is used as the first fluorescent material.

### Arrangement And Shape of Light Emitting Section 5

The light emitting section 5 is fixed to a focal point of the reflector 6 or in the vicinity of the focal point inside the transmission filter 7 (on a side where the light emitting surface 4b is located). However, how to fix the light emitting section 5 is not limited to this. Alternatively, the light emitting section 5 can be fixed by a rod-like or tubular member that extends from the reflector 6.

A shape of the light emitting section 5 is not limited to a specific one. The shape of light emitting section 5 can be a rectangular parallelepiped or columnar shape. The light emitting section 5 of the present embodiment is columnar with a diameter of 2 mm and a thickness (height) of 0.8 mm. A laser beam irradiated surface of the light emitting section 5 which is irradiated with laser beams is not necessarily planar, and can therefore be curved. However, the laser beam irradiated surface is preferably planar so as to be perpendicular to an axis of the laser beams, in view of controlling of reflection of the laser beams. In a case where the laser beam irradiated surface is curved, at least angles at which the laser beams enter greatly differ from location to location. This causes a direction, in which reflected laser beams travel, to greatly differ depending on where the laser beams are irradiated. As such, it is sometimes difficult to control the direction in which the laser beams are reflected. In contrast, in a case where the laser beam irradiated surface is planar, the direction in which reflected laser beams travel is almost the same even in a case where a location to be irradiated with the laser beams slightly deviates. This makes it easy to control the direction in which the laser beams are reflected. In some cases, it becomes easier to take measures such as providing of an absorbent member in a place to be irradiated with reflected laser beams.

The thickness of the light emitting section 5 is not limited to 0.8 mm. A requisite thickness of the light emitting section 5 changes depending on a ratio between a sealant and a fluorescent material in the light emitting section 5. In a case where the content of the fluorescent material increases in the light emitting section 5, an efficiency at which laser beams are converted into white light is increased. This allows a reduction in the thickness of the light emitting section 5.

### Reflector 6

The reflector 6 has an opening, forms a bundle of light beams that travels within a predetermined solid angle by reflecting incoherent light emitted by the light emitting section 5, and then emits the bundle of light beams via the opening. That is, the reflector 6 forms the bundle of light beams that travels ahead of the headlamp 1, by reflecting light emitted from the light emitting section 5. The reflector 6 is, for example, a curved (cupped) member on which surface a metal thin film is formed, and has the opening in the direction where reflected light travels.

The reflector 6 is not limited to a semispherical mirror. Alternatively, the reflector 6 can be an elliptical mirror, a parabolic mirror or a mirror partially having an elliptical or parabolic surface. That is, the reflector 6 can have a reflection surface that is at least part of a curved surface obtained by rotating a graphic (ellipse, circle or parabola) about a rotation axis. A shape of the opening of the reflector 6 is not limited to a circular form. The shape of the opening can be determined as appropriate in accordance with the headlamp 1 and a peripheral design of the headlamp 1.

### Transmission Filter 7

The transmission filter 7 is a transparent resin plate (a resin plate for selectively transmitting light having a predetermined wavelength domain) that covers the opening of the reflector 6. The transmission filter 7 holds the light emitting section 5. The transmission filter 7 is preferably made from a material for shielding laser beams emitted from the semiconductor laser 2 and for transmitting white light into which the light emitting section 5 converts the laser beams. Other than the resin plate, an inorganic glass or the like can be used as the material of the transmission filter 7. For example, ITY408 manufactured by Isuzu Glass Co., Ltd. can be used as the transmission filter 7.

The light emitting section 5 converts most of laser beams including plenty of coherent components into incoherent light. However, it can be considered that some of the laser beams are not converted into incoherent light due to some reasons. Even in this case, it is possible to prevent the laser beams from leaking outside by shielding the laser beams with the use of the transmission filter 7.

Note that the transmission filter 7 does not need to shield all of the laser beams and transmit all fluorescence emitted from the light emitting section 5. That is, the transmission filter 7 does not necessarily shield all of harmful coherent components included in laser beams, provided that a transmitting amount of the harmful coherent components is not more than a secure level. Further, the transmission filter 7 does not necessarily transmit all of the fluorescence, provided that the light emitting section 5 emits fluorescence amount sufficient for white light of the headlamp 1 (or fluorescence having a sufficiently high color temperature).

In the headlamp 1, the light emitting section 5 thus emits light while receiving the laser beams from the semiconductor laser 2, and then emits fluorescence via the transmission filter 7. In this case, since the laser beams are shielded by the transmission filter 7, the laser beams do not leak outside. This makes it possible to prevent human eyes from being damaged due to outward emission of exciting light that has not been converted into fluorescence (or that has not been scattered).

In a case where a light emitting diode is used as an excitation light source, it is not necessary to shield light emitted from the light emitting diode because incoherent light is emitted from the light emitting diode. This makes it possible to emit, outside the illumination apparatus, the light emitted from the light emitting diode as it is. In contrast, in a case where the semiconductor laser is used as the excitation light source, the light emitted from the semiconductor laser should be shielded because coherent light is emitted from the semiconductor laser, as described above. On this account, the transmission filter 7 is provided in the present embodiment.

That is, in the case where the light emitting diode is used as the excitation light source, it is unnecessary in the first place to consider (i) a decrease in color temperature due to the transmission filter 7 and (ii) a security against outward emission of coherent light, because the color temperature can be increased by outward emission of the light emitted from the light emitting diode. Conversely, in the case of using the semiconductor laser as described in the present embodiment, it is necessary to design the headlamp 1 by taking into consideration (i) the decrease in color temperature due to the transmission filter 7 and (ii) the above security. In the headlamp 1 of the present embodiment, the first fluorescent material (for example, a JEM phase:Ce fluorescent material) rich in blue components is used as a fluorescent material. This makes it possible to increase a color temperature of white light even in a case where laser beams are shielded. That is, the headlamp 1 can emit white light having a desired high color temperature while preventing the laser beams from leaking outside the headlamp 1 even in a case where the headlamp 1 includes the semiconductor laser 2 and the transmission filter 7. In other words, the headlamp 1 can emit white light that secures safety and that has a high color temperature.

### Configuration of Semiconductor Laser 2

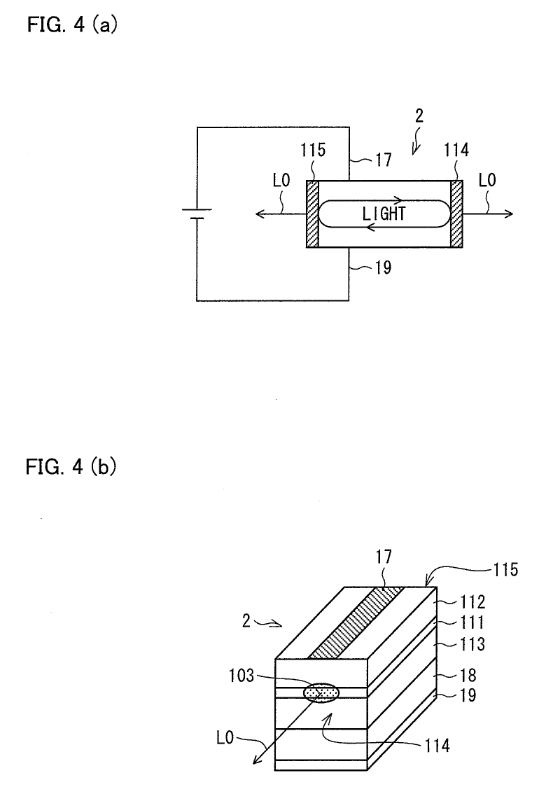

The following describes a basic configuration of the semiconductor laser 2. FIG. 4(a) is a view schematically showing a circuit of the semiconductor laser 2. FIG. 4(b) is a perspective view showing a basic configuration of the semiconductor laser 2. As shown in FIG. 4(b), the semiconductor laser 2 includes a cathode electrode 19, a substrate 18, a clad layer 113, an active layer 111, a clad layer 112, and an anode electrode 17 that are laminated in this order.

The substrate 18 is preferably a semiconductor substrate made from GaN, sapphire or SiC so that blue through ultraviolet exciting light that excites the fluorescent material is generated in the present embodiment. Other examples of the substrate 18 of the semiconductor laser encompass (i) a IV semiconductor such as Si, Ge or Sic, (ii) a III-V compound semiconductor such as GaAs, GaP, InP, AlAs, GaN, InN, InSb, GaSb or AlN, (iii) a II-VI compound semiconductor such as ZnTe, ZeSe, ZnS or ZnO, (iv) an oxide insulator such as ZnO, Al₂O₃, SiO₂, TiO₂, CrO₂ or CeO₂, and (v) a nitride insulator such as SiN.

The anode electrode 17 injects electric current into the active layer 111 via the clad layer 112.

The cathode electrode 19 injects electric current into the active layer 111 via the clad layer 113 from a lower part of the substrate 18. Note that the injection of the electric current into the active layer 111 is carried out by applying a forward bias to the anode electrode 17 and the cathode electrode 19.

The active layer 111 is sandwiched between the clad layer 113 and the clad layer 112.

The active layer 111 and the clad layers are made from a mixed crystal semiconductor of AlInGaN so that blue through ultraviolet exciting light is generated. Generally, an active layer and clad layers of a semiconductor laser are made from a mixed crystal semiconductor containing Al, Ga, In, As, P, N, and Sb as main components. The active layer 111 and the clad layers 112 and 113 of the present embodiment can be made from the mixed crystal semiconductor containing Al, Ga, In, As, P, N, and Sb as main components. Alternatively, the active layer 111 and the clad layers 112 and 113 can be made from Zn, Mg, S, Se, Te and a II-VI compound semiconductor such as ZnO.

The active layer 111 is a region where light is generated by injection of electric current into the active layer 111. The light generated in the region is kept in the active layer 111 due to a difference in refractivity between the active layer 111 and the clad layers 112 and 113.

The active layer 111 includes a front-side cleavage surface 114 and a backside cleavage surface 115, which face each other, provided so that light amplified by stimulated emission is kept in the active layer 111. The front-side cleavage surface 114 and the backside cleavage surface 115 serve as respective mirrors.

Note, however, that the front-side cleavage surface 114 and the backside cleavage surface 115 do not completely reflect light, unlike a mirror. Some of the light amplified by the stimulated emission is emitted as laser beams (exciting light) LO from the front-side cleavage surface 114 and the backside cleavage surface 115 of the active layer 111 (in the present embodiment, for the sake of convenience, from the front-side cleavage surface 114). Note that the active layer 111 can have a multilayered quantum well structure.

The backside cleavage surface 115 facing the front-side cleavage surface 114 has a reflection film (not shown) for laser oscillation. This causes a difference in reflectivity between the front-side cleavage surface 114 and the backside cleavage surface 115. Such a difference in reflectivity allows most of the laser beams (exciting light) L0 to be emitted, via a light emitting point 103, for example, from the front-side cleavage surface 114 that is a low reflectivity end surface.

The clad layer 113 and the clad layer 112 can be made from an n-type semiconductor and a p-type semiconductor, respectively, or vice versa, provided that electric current can be injected into the active layer 111 through the clad layers 113 and 112 by applying a forward bias to the anode electrode and the cathode electrode 19. Examples of the semiconductor encompass (i) a III-V compound semiconductor such as GaAs, GaP, InP, AlAs, GaN, InN, InSb, GaSb or AlN and (ii) a II-VI compound semiconductor such as ZnTe, ZeSe, ZnS or ZnO.

Semiconductor layers such as the clad layers 113 and 112 and the active layer 111 can be deposited by a general deposition technique such as an MOCVD (metalorganic chemical vapor deposition) method, an MBE (molecular beam epitaxy) method, a CVD (chemical vapor deposition) method, a laser ablation method or a sputtering method. Metal layers of the semiconductor laser 2 can be deposited by a general deposition technique such as a vacuum evaporation method, a plating technique, a laser ablation method or a sputtering method.

### Principle of Light Emission of Light Emitting Section 5

The following describes a principle of how a fluorescent material emits light by use of laser beams emitted from the semiconductor laser 2.

Firstly, the fluorescent material included in the light emitting section 5 is irradiated with laser beams emitted from the semiconductor laser 2. This causes electrons included in the fluorescent material to be excited so that a transition occurs to a high energy state (excited state) from a low energy state.

Thereafter, a transition of the energy state of the electrons included in the fluorescent material to a low energy state (a ground level or a metastable level between an excited level and a ground level) occurs in a certain period of time. This is because the excited state of the electrons is unstable.

The transition of the energy state of the electrons from the high energy state to the low energy state causes the fluorescent material to emit light.

White light can be achieved by a color mixture of three colors that meet an isochromatic principle or by a color mixture of two colors that meet a complementary color relationship. The white light can be generated by combining a color of laser beams emitted from a semiconductor laser with a color of light emitted from a fluorescent material on the basis of the isochromatic principle or the complementary color relationship.

### Another Example of Headlamp

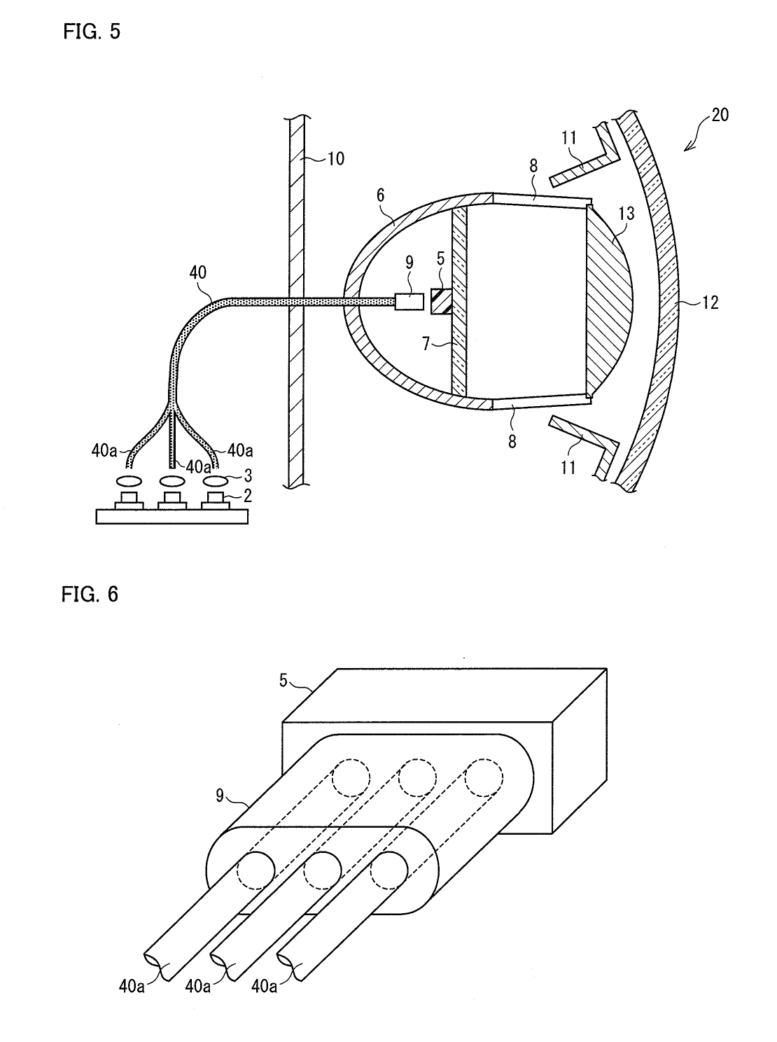

The following describes another example of the present embodiment with reference to FIG. 5. Note that like reference numerals herein refer to corresponding members of the headlamp 1, and descriptions of such members are omitted here. In this example, a projector headlamp 20 is described.

### Configuration of Headlamp 20

Firstly, a configuration of the headlamp 20 in accordance with the present embodiment is described with reference to FIG. 5. FIG. 5 is a cross-sectional view showing a configuration of the headlamp 20 that is a projector headlamp. The headlamp 20 is different from the headlamp 1 in that the headlamp 20 is a projector headlamp and includes an optical fiber 40 instead of the light guiding section 4.

As shown in FIG. 5, the headlamp 20 includes a semiconductor laser 2, an aspheric lens 3, the optical fiber (light guiding section) 40, a ferrule 9, a light emitting section 5, a reflector 6, a transmission filter 7, a housing 10, an extension 11, a lens 12, a convex lens 13, and a lens holder 8. The semiconductor laser 2, the optical fiber 40, the ferrule 9, and the light emitting section 5 constitute a basic configuration of the headlamp 20.

The headlamp 20 is the projector headlamp, and therefore includes the convex lens 13. The present invention is applicable to another type of headlamp such as a semi-shield beam headlamp. In this case, the convex lens 13 does not need to be provided in the semi-shield beam headlamp.

### Aspheric Lens 3

The aspheric lens 3 is a lens for causing laser beams (exciting light) emitted from the semiconductor laser 2 to enter an incident end part that is an end part of the optical fiber 40. The aspheric lens 3 is provided in the headlamp 20 so as to be equal in number to the optical fiber 40a.

### Optical Fiber 40

The optical fiber 40 is a light guiding member for guiding, to the light emitting section 5, the laser beams emitted from the semiconductor laser 2, and is made up from a plurality of optical fibers 40a. The optical fiber 40 has a two layer structure in which a center core is surrounded by a clad whose refractivity is lower than that of the center core. The center core contains, as a main ingredient, quartz glass (silicon oxide) that causes very little absorption loss of the laser beams. The clad contains, as a main ingredient, quartz glass or a synthetic resin material that has refractivity lower than that of the center core.

For example, in the optical fiber 40 made from quartz, the core has a diameter of 200 μm, the clad has a diameter of 240 μm, and a numerical aperture NA is 0.02. However, a configuration, a diameter and a material of the optical fiber 40 are not limited to the above-described ones. Alternatively, the optical fiber 40 can have an oblong cross section perpendicular to a longitudinal direction of the optical fiber 40.

The optical fiber 40 includes a plurality of incident end parts where the laser beams are received, and a plurality of light emitting end parts from which the laser beams that have entered the incident end parts are emitted. The plurality of light emitting end parts are positioned, by the ferrule 9, so as to face a laser beam irradiated surface (light receiving surface) of the light emitting section 5, as later described.

### Ferrule 9

FIG. 6 is a view showing a positional relationship of the light emitting end parts of the optical fibers 40a with the light emitting section 5. As shown in FIG. 6, the ferrule 9 holds the light emitting end parts of the optical fibers 40a in a predetermined pattern such that the light emitting end parts of the optical fibers 40a face the laser beam irradiated surface of the light emitting section 5. The ferrule 9 can be configured so as to have, in a predetermined pattern, through-holes through which the optical fibers 40a are inserted. Alternatively, the ferrule 9 can be configured (i) so as to have detachable upper and lower parts which are combined with each other via respective combining surfaces and have first and second grooves, respectively, and (ii) so that each of the optical fibers 40a is sandwiched between a corresponding one of the first grooves and a corresponding one of the second grooves.

A material for the ferrule 9 is not limited to a specific one. The ferrule 9 can be made from, for example, stainless steel. In FIG. 6, three optical fibers 40a are shown. However, the number of the optical fibers 40a is not limited to three. The ferrule 9 can be fixed by, for example, a rod-like member that extends from the reflector 6.

As described above, the ferrule 9 positions the light emitting end parts of the optical fibers 40a. This allows different regions of the laser beam irradiated surface of the light emitting section 5 to be irradiated with maximum light intensity parts of light intensity distributions of the laser beams emitted from the respective optical fibers 40a. It is therefore possible to prevent the light emitting section 5 from being extremely deteriorated because the laser beams are converged onto a single specific point of the light emitting section 5. The light emitting end parts can contact with the laser beam irradiated surface or can alternatively be provided to be away, by a slight interval, from the laser beam irradiated surface.

The light emitting end parts of the optical fibers 40a are not necessarily provided so as to be away from one another. Alternatively, a bundle of the optical fibers 40a can be positioned by the ferrule 9.

### Light Emitting Section 5

The light emitting section 5 emits white fluorescence while being irradiated with the laser beams emitted from a light emitting end part of the optical fiber 40, and includes the first fluorescent material containing plenty of blue components, as with the above-described light emitting section 5. This allows the light emitting section 5 to emit white light having a high color temperature. The light emitting section 5 is provided in the vicinity of a first focal point of the reflector 6 (later described). The light emitting section 5 can be fixed to an end of a tubular part that penetrates a center part of the reflector 6. In this case, the optical fiber 40 can pass through the tubular part.

### Reflector 6

The reflector 6 is a member on which surface a metal thin film is formed. The reflector 6 reflects and focalizes light emitted from the light emitting section 5. Since the headlamp 20 is the projector headlamp, the reflector 6 basically has an elliptical cross section parallel to an axis direction of reflected light. The reflector 6 has the first focal point and a second focal point that is closer to an opening of the reflector 6 than the first focal point is. The convex lens 13 (later described) is provided so as to have a focal point in the vicinity of the second focal point, and projects frontward the light converged on the second focal point by the reflector 6.

### Transmission Filter 7

The transmission filter 7 shields exciting light, transmits fluorescence emitted from the light emitting section 5, and holds the light emitting section 5, as early described. The transmission filter 7 can prevent laser beams from leaking outside the headlamp 20.

### Convex Lens 13

The convex lens 13 converges the light emitted from the light emitting section 5, and then projects converged light ahead of the headlamp 20. The convex lens 13 has its focal point in the vicinity of the second focal point of the reflector 6. The convex lens 13 has a light axis that penetrates a substantially center part of a light emitting surface of the light emitting section 5. The convex lens 13 is held by the lens holder 8. This determines a relative position of the convex lens 13 to the reflector 6. The lens holder 8 can be provided to be part of the reflector 6.

### Other Members

The housing 10 constitutes a main body of the headlamp 20, and houses the reflector 6 and other members. The optical fiber 40 penetrates the housing 10. The semiconductor laser 2 is provided outside the housing 10. The semiconductor laser 2 generates heat while the semiconductor laser 2 is emitting laser beams. Since the semiconductor laser 2 is provided outside the housing 10, the semiconductor laser 2 can be efficiently cooled down. Further, it is preferable that the semiconductor laser 2 be provided so that the semiconductor laser 2 is easily exchangeable because the semiconductor laser 2 is likely to break down. If these regards are not considered, the semiconductor laser 2 can be provided in the housing 10.

The extension 11 is provided on sides in front of the reflector 6. The extension 11 not only hides an inner structure of the headlamp 20 so as to improve an appearance of the headlamp 20 but also causes people to more strongly feel as if the reflector 6 were integral with a vehicle body. The extension 11 is a member on which surface a metal thin film is formed, as with the surface of the reflector 6.

The lens 12 is provided in an opening of the housing 10, and seals the headlamp 20. The light emitted by the light emitting section 5 is emitted ahead of the headlamp 20 via the lens 12.

As described above, the headlamp of the present invention is not limited to a specific structure. What is important in the present invention is that (i) a headlamp includes the transmission filter 7 for shielding the laser beams emitted from the semiconductor laser 2 and (ii) the light emitting section 5, including the first fluorescent material containing plenty of blue components, can emit white light having a high color temperature.

### Embodiment 2

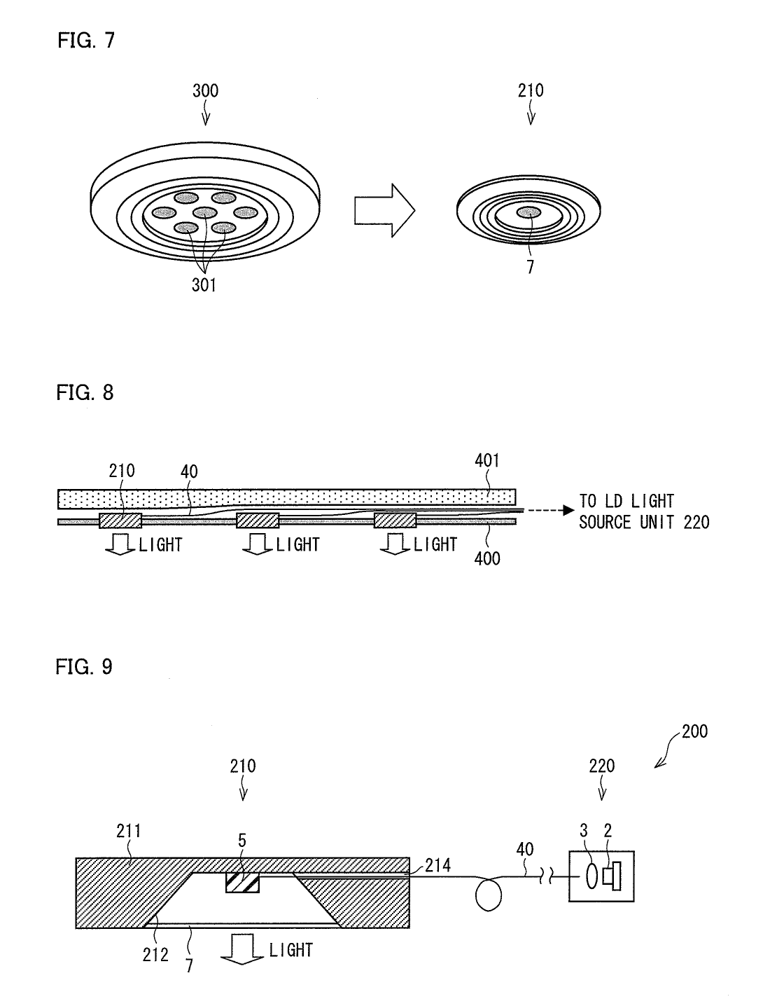

The following describes another embodiment of the present invention with reference to FIGS. 7 through 12. Note that like reference numerals herein refer to corresponding members of Embodiment 1, and descriptions of such members are omitted here.

In this embodiment, a laser down light 200 is described as an example of the illumination apparatus of the present invention. The laser down light 200 is an illumination apparatus that is provided on a ceiling of a structure such as a house or a vehicle. The laser down light 200 employs, as illumination light, fluorescence generated by irradiation of the light emitting section 5 with the laser beams emitted from the semiconductor laser 2.

Note that another illumination apparatus having a configuration identical to that of the laser down light 200 can be provided on a sidewall or floor of a structure. A place where the illumination apparatus is provided is not limited to a specific place.

FIG. 7 is a schematic diagram showing external appearances of a light emitting unit 210 and a conventional LED down light 300. FIG. 8 is a cross-sectional view of a ceiling on which the laser down light 200 is provided. FIG. 9 is a cross-sectional view showing the laser down light 200. As shown in FIGS. 7 through 9, the laser down light 200 is embedded in a top board 400, and includes (i) light emitting units 210 that emits illumination light and (ii) an LD light source unit 220 that supplies laser beams to the light emitting units 210 via the respective optical fibers 40. The LD light source unit 220 is not provided on the ceiling but provided in a place (for example, a sidewall of a house) which a user can easily reach. The reason why where the LD light source unit 220 is provided can be freely determined is that the LD light source unit 220 and the light emitting units 210 are connected to each other via the respective optical fibers 40. The optical fibers 40 are provided in a space between the top board 400 and a heat insulating material 401.

### Configuration of Light Emitting Unit 210

The light emitting unit 210 includes a housing 211, the optical fiber 40, the light emitting section 5 and the transmission filter 7, as shown in FIG. 9.

The housing 211 has formed a concave part 212. The light emitting section 5 is provided on a bottom surface of the concave part 212. The concave part 212 has a surface on which a metal thin film is formed. The concave part 212 functions as a reflector.

The housing 211 also has a path 214 that allows the optical fiber 40 to extend up to the light emitting section 5 via the path 214. A positional relationship of the light emitting end part of the optical fiber 40 with the light emitting section 5 is identical to that described above (see FIG. 6).

The transmission filter 7 is a transmittable resin plate for transmitting light having a specific wavelength domain, and is provided so as to close up an opening of the concave part 212. It is preferable that the transmission filter 7 be made from a material for (i) shielding the laser beams emitted from the semiconductor laser 2 and (ii) transmitting white light into which the light emitting section 5 converts the laser beams.

In FIG. 7, the light emitting unit 210 has a circular shape. However, a shape of the light emitting unit 210 (more specifically, a shape of the housing 211) is not limited to a specific one.

Note that a down light is different from a headlamp in that the down light does not need to have an ideal point source but needs to have only one light emitting point. Therefore, a shape, a size and a location of the light emitting section 5 of the down light are less restricted than those of the headlamp.

### Configuration of LD Light Source Unit 220

The LD light source unit 220 includes the semiconductor laser 2, the aspheric lens 3 and the optical fiber 40.

An end part of the optical fiber 40 is connected to the LD light source unit 220. The laser beams emitted from the semiconductor laser 2 enter the incident end part of the optical fiber 40 via the aspheric lens 3.

The LD light source unit 220 shown in FIG. 9 includes merely a pair of the semiconductor laser 2 and the aspheric lens 3. Note, however, that, in a case where a plurality of light emitting units 210 are provided, a bundle of the optical fibers 40 that extend from the respective plurality of light emitting units 210 can be connected to a single LD light source unit 220. In this case, the single LD light source unit 220 contains plural pairs of the semiconductor laser 2 and aspheric lens 3, and therefore functions as a central power source box.

### Modified Example of a Method For Providing the Laser Down Light 200

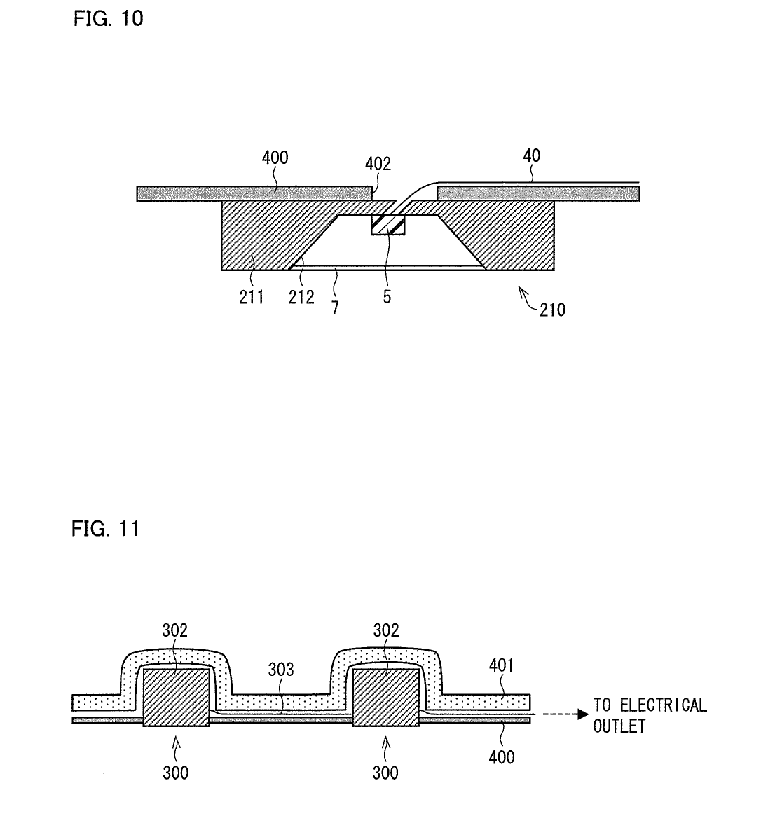

FIG. 10 is a cross-sectional view showing a modified example of a method for providing the laser down light 200. According to the modified example (see FIG. 10), a main body of the laser down light 200 (light emitting unit 210) can be attached, by use of, for example, a strong adhesive tape, to the top board 400 having a small through-hole 402 for causing only the optical fiber 40 to pass therethrough. The reason why the main body can be attached to the top board 400 is that the main body has features of thinness in thickness and lightness in weight. This makes it possible to alleviate a restriction on provision of the laser down light 200, and to remarkably reduce a cost for providing the laser down light 200.

### Comparison of the Laser Down Light 200 With the Conventional LED Down Light 300

As shown in FIG. 7, the conventional LED down light 300 includes a plurality of light transmitting plates 301 from each of which illumination light is emitted. That is, the LED down light 300 has a plurality of light emitting points. The reason why the LED down light 300 should have the plurality of light emitting points is that, since light flux individually emitted from the plurality of light emitting points is relatively small, sufficient light flux cannot be obtained unless the LED down light 300 has the plurality of light emitting points.

In contrast, the laser down light 200 is an illumination apparatus having large light flux, and therefore a single light emitting point is sufficient. This brings about an effect of obtaining clear shade derived from illumination light. A color rendering property of illumination light can be enhanced in a case where a high color rendering fluorescent material (e.g. any combination of plural kinds of oxynitride fluorescent material and/or nitride fluorescent material) is used as the fluorescent material of the light emitting section 5.

FIG. 11 is a cross-sectional view of a ceiling on which an LED down light 300 is provided. According to the LED down light 300 shown in FIG. 11, a housing 302, which houses an LED chip, a power source and a cooling unit, is embedded in a top board 400. The housing 302 is relatively large in size. The heat insulating material 401 has a concave part in which the housing 302 fits. The housing 302 is provided in the concave part of the heat insulating material 401. The housing 302 is connected to a power source line 303. The power source line 303 is connected to an electrical outlet (not shown).

Such a configuration of the LED down light 300 will cause the following problem: A temperature of a ceiling is increased by usage of the LED down light 300, and therefore a cooling efficiency of a room is decreased. This is because the light source (LED chip) and the power source, that serve as respective heat generating sources, are provided between the top board 400 and the heat insulating material 401.

The LED down light 300 causes another problem of an increase in a total cost. This is because each light source requires a corresponding power source and a corresponding cooling unit.

The LED down light 300 causes a further problem that it is often the case that it is difficult to provide the LED down light 300 in a space between the top board 400 and the heat insulating material 401. This is because the housing 302 is relatively large in size.

In contrast, since the light emitting unit 210 of the laser down light 200 includes no large heat generating source, a cooling efficiency of a room will never be decreased. It is therefore possible to prevent an increase in cost for cooling the room.

It is also possible to reduce the laser down light 200 in its size and thickness because each light emitting unit 210 does not require a corresponding power source and corresponding cooling unit. This brings about an effect of alleviating a restriction on a space where the laser down light 200 is provided, and therefore it becomes easy to provide the laser down light 200 in an existing house.

Since the laser down light 200 is thin and light in weight, as early described, it is possible to (i) provide the light emitting unit 210 on a surface of the top board 400, (ii) make smaller the restriction on the provision of the laser down light 200 as compared with the provision of the LED down light 300 because the space between the heat insulating material 401 and the top board 400 is hardly required, and (iii) remarkably reduce the cost for providing the laser down light 200.

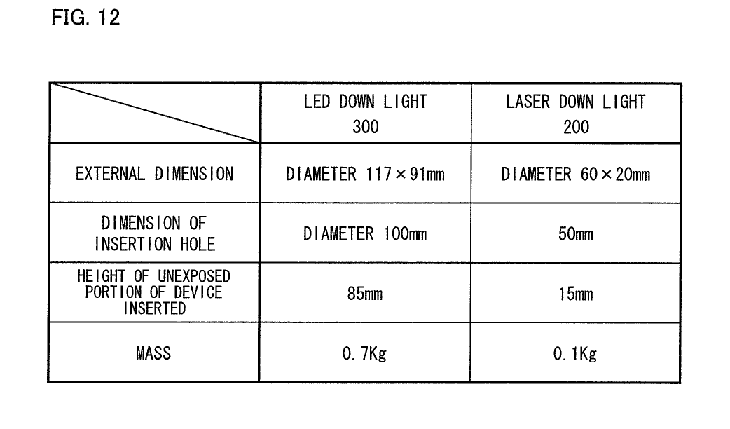

FIG. 12 shows a comparison of specifications between the laser down light 200 and the LED down light 300. According to the comparison shown in FIG. 12, the laser down light 200 has a volume of 94% of and a mass of 86% of the LED down light 300.

It is further possible to provide the LD light source unit 220 in a place (height) that a user easily reaches. This makes it easy to exchange the semiconductor laser 2 even in a case where the semiconductor laser 2 breaks down. Further, it is possible to collectively control a plurality of semiconductor lasers 2 by guiding, to a single LD light source unit 220, the optical fibers 40 extending from a plurality of light emitting units 210. Hence, the plurality of semiconductor lasers 2 can be easily exchanged.

In a case where a high color rendering fluorescent material is used as a fluorescent material of the LED down light 300, it is necessary for the LED down light 300 to consume a power of 10 W for causing the LED down light 300 to emit a light flux of approximately 500 lm. In contrast, it is necessary for the laser down light 200 to consume a power of 3.3 W (optical output) for causing the laser down light 200 to emit a light flux of approximately 500 lm. The optical output of 3.3 W corresponds to a power consumption of 10 W in a case where an LD efficiency is 35%. Since the LED down light 300 consumes a power of 10 W, there is no substantial difference in power consumption between the laser down light 200 and the LED down light 300. Hence, the laser down light 200 brings the above-described various advantages with a power consumption identical to that of the LED down light 300.

As described above, the laser down light 200 includes the light source unit 220 including at least one semiconductor laser 2 for emitting laser beams, at least one light emitting unit 210 that includes (i) the light emitting section 5 and (ii) the concave part 212 serving as a reflector, and the transmission filter 7 for shielding the laser beams and transmitting fluorescence emitted from the light emitting section 5. The light emitting section 5 includes at least the first fluorescent material having a peak of emission spectrum which peak falls within a range from 450 nm to 500 nm, and emits white light while it is irradiated with the laser beams.

This allows the laser down light 200, as with the headlamps 1 and 20 of Embodiment 1, to emit white light that secures safety of human eyes and that has a high color temperature.

### Another Description of the Present Invention

The present invention can also be described as below.

It is preferable to configure an illumination apparatus in accordance with an embodiment of the present invention such that the first fluorescent material be an oxynitride fluorescent material containing JEM phase.

According to the configuration, it is possible to provide the light emitting section including the first fluorescent material which has the peak of emission spectrum which peak falls within a range from 450 nm to 500 nm.

It is preferable to configure the illumination apparatus in accordance with an embodiment of the present invention such that the excitation light source emit exciting light having a peak of oscillation wavelength which peak falls within a range from 350 nm to 420 nm.

According to the configuration, since the light emitting section can be irradiated with the exciting light having the peak of oscillation wavelength which peak falls within a range from ultraviolet light to bluish purple visible light (not less than 350 nm but not more than 380 nm or less than 400 nm), it is possible to excite, at a high efficiency (approximately 60%), the oxynitride fluorescent material containing JEM phase. Further, the oxynitride fluorescent material containing JEM phase can also be excited at a high efficiency (approximately 50%) even in a case where the peak of oscillation wavelength falls within a bluish purple range from 400 nm to 420 nm. That is, according to the configuration, it is possible to produce an illumination apparatus including a light emitting section capable of (i) being excited at such high efficiencies and (ii) emitting white light having a high color temperature.

It is preferable to configure the illumination apparatus in accordance with an embodiment of the present invention such that the light emitting section include a second fluorescent material having a peak of emission spectrum which peak falls within a range from 630 nm to 650 nm.

According to the configuration, since the light emitting section includes not only the first fluorescent material but also the second fluorescent material that is a red fluorescent material, it is possible to attain white light having a remarkably high color temperature. Since the second fluorescent material is the red fluorescent material, in a case where a target to be irradiated with the white light is red, the red fluorescent material makes it possible to enhance a visibility to the target.

It is preferable to configure the illumination apparatus in accordance with an embodiment of the present invention such that the second fluorescent material be a CaAlSiN₃:Eu fluorescent material or a SrCaAlSiN₃:Eu fluorescent material.

According to the configuration, it is possible to provide the light emitting section including the second fluorescent material having the peak of emission spectrum which peak falls within a range from 630 nm to 650 nm.

A vehicular headlamp in accordance with an embodiment of the present invention, including: the illumination apparatus; and a reflector for reflecting the fluorescence emitted from the light emitting section so as to form a light flux that travels within a predetermined solid angle.

According to the configuration, the reflector reflects light emitted from the light emitting section so as to form a light flux that travels ahead of the vehicular headlamp. Since the vehicular headlamp includes the illumination apparatus, it is possible to increase a color temperature of white light emitted from the light emitting section, with use of the blue components of the first fluorescent material included in the light emitting section even in a case where the transmission filter transmits the white light. This allows the vehicular headlamp, as with the illumination apparatus, to emit white light that secures safety and that has a high color temperature.

The illumination apparatus in accordance with an embodiment of the present invention relates to a laser illumination light source including (i) a fluorescent material light emitting section and (ii) a semiconductor laser serving as an excitation light source having an oscillation wavelength of approximately 405 nm that is in a bluish purple range. A JEM:Ce³⁺ fluorescent material and a fluorescent material that emits red through orange light are used as a fluorescent material of the fluorescent material light emitting section, and the illumination apparatus further includes a filter for shielding exciting light emitted from the semiconductor laser light source. This makes it possible to obtain illumination light that secures safety of eyes and that has a high color temperature.

The present invention is not limited to the description of the embodiments, and can therefore be modified by a skilled person in the art within the scope of the claims. Namely, an embodiment derived from a proper combination of technical means disclosed in different embodiments is encompassed in the technical scope of the present invention.

### INDUSTRIAL APPLICABILITY

The present invention is applicable to an illumination apparatus or a headlamp, particularly to a headlamp for use in, for example, a vehicle, which should emit illumination light having a high color temperature.

### REFERENCE SIGNS LIST

1: headlamp (illumination apparatus or vehicular headlamp)
2: semiconductor laser (excitation light source)
5: light emitting section
6: reflector
7: transmission filter
20: headlamp (illumination apparatus or vehicular headlamp)

1. An illumination apparatus, comprising:
an excitation light source for emitting exciting light;
a light emitting section that includes a first fluorescent material having a peak of emission spectrum which peak falls within a range from 450 nm to 500 nm, and that emits white fluorescence while being irradiated with the exciting light emitted from the excitation light source; and
a transmission filter for shielding the exciting light and transmitting the fluorescence emitted from the light emitting section.

2. The illumination apparatus as set forth in claim 1, wherein:
the first fluorescent material is an oxynitride fluorescent material containing JEM phase.

3. The illumination apparatus as set forth in claim 2, wherein:
the excitation light source emits the exciting light having a peak of oscillation wavelength which peak falls within a range from 350 nm to 420 nm.

4. The illumination apparatus as set forth in claim 1, wherein:
the light emitting section includes a second fluorescent material having a peak of emission spectrum which peak falls within a range from 630 nm to 650 nm.

5. The illumination apparatus as set forth in claim 4, wherein:
the second fluorescent material is a CaAlSiN₃:Eu fluorescent material or a SrCaAlSiN₃:Eu fluorescent material.

6. A vehicular headlamp, comprising:
an illumination apparatus as set forth in claim 1; and
a reflector for reflecting the fluorescence emitted from the light emitting section so as to form a light flux that travels within a predetermined solid angle.
